(19) United States
(12) Patent Application Publication
(10) Pub. No.: US 2025/0055034 A1
(43) Pub. Date: Feb. 13, 2025

(54) ELECTROLYTE SOLUTION AND BATTERY INCLUDING THE SAME

(71) Applicant: ZHUHAI COSMX POWER BATTERY CO., LTD., Zhuhai (CN)

(72) Inventors: Hui ZHU, Zhuhai (CN); Yujuan YUE, Zhuhai (CN); Jianming LIU, Zhuhai (CN)

(73) Assignee: ZHUHAI COSMX POWER BATTERY CO., LTD., Zhuhai (CN)

(21) Appl. No.: 18/925,365

(22) Filed: Oct. 24, 2024

Related U.S. Application Data
(63) Continuation of application No. PCT/CN2023/088441, filed on Apr. 14, 2023.

(30) Foreign Application Priority Data
Jun. 29, 2022 (CN) 202210761471.9

(51) Int. Cl. H01M 10/0567; H01M 4/02; H01M 4/525; H01M 10/0525; H01M 10/0568

(52) U.S. Cl. CPC H01M 10/0567; H01M 4/525; H01M 10/0525; H01M 10/0568; H01M 2004/028

(57) ABSTRACT

Disclosed are an electrolyte solution and a battery including the same. In the electrolyte solution provided in the present disclosure, a nitrogen-containing heterocyclic compound containing a sulfonate group or a sulfone group is a dual-function additive, where there is a lone pair on its N atom; after a small amount of the compound is added to the electrolyte solution, relatively weak Lewis basicity is presented; and the compound can form a complex (for example, a six-ligand complex) with another component (for example, PFs) in the electrolyte solution. Therefore, acidity and reactivity of the electrolyte solution are reduced; increase of a free acid in the electrolyte solution is inhibited; and lithium deposition at a negative electrode of a high-voltage battery may be inhibited while the high-temperature cycling performance, normal-temperature cycling performance, low-temperature discharge performance, and rate performance of the battery are improved.

### CROSS-REFERENCE TO RELATED APPLICATIONS

The present disclosure is a continuation of International Application No. PCT/CN2023/088441, filed on Apr. 14, 2023, which claims priority to Chinese Patent Application No. 202210761471.9, filed on Jun. 29, 2022. All of the aforementioned patent applications are hereby incorporated by reference in their entireties.

### TECHNICAL FIELD

The present disclosure pertains to the field of lithium-ion battery technologies, and specifically relates to an electrolyte solution and a battery including the same.

### BACKGROUND

A secondary battery has remarkable advantages such as high specific energy, high specific power, long cycle life, and small self-discharge. Lithium-ion batteries are a common type of secondary batteries. Commercial lithium-ion batteries mainly have the following types of positive electrode materials: lithium manganate oxide, lithium cobalt oxide, a ternary material, and lithium iron phosphate. Generally, a charge cut-off voltage of a commercial lithium-ion battery does not exceed 4.2 V. With the advancement of science and technology and continuous development of the market, it is increasingly important and urgent to improve the energy density of a lithium-ion battery.

In addition to improving manufacturing processes of existing materials and batteries, providing high-voltage (4.35 V to 5 V) positive electrode materials is one of relatively hot research directions. High energy density of a battery is implemented by increasing a charging depth of a positive electrode active material of the battery. However, after an operating voltage of a battery using a ternary material is increased, performance such as charge-discharge cycling performance of the battery is decreased. As an important component of a lithium-ion battery, an electrolyte solution has a great influence on performance such as charge-discharge cycling performance of the battery. The electrolyte solution not only determines a migration rate of lithium ions (Li⁺) in a liquid phase, but also participates in forming of a solid electrolyte interphase (SEI) film, and thus plays a key role in performance of the SEI film. As a result, the electrolyte solution may lead to relatively poor high-temperature storage performance, relatively poor high-temperature cycling performance, and relatively poor normal-temperature cycling performance of the lithium-ion battery under a high-voltage condition. Moreover, viscosity of the electrolyte solution increases at a low temperature, leading to a conductivity decrease and impedance increase of the SEI film. As a result, the electrolyte solution may also lead to relatively poor low-temperature discharge performance of the lithium-ion battery, or even to a risk of low-temperature lithium deposition. Therefore, there is an urgent need to research and develop an electrolyte solution having excellent performance in various aspects, to meet a usage requirement for a battery having high energy density and using a ternary material.

### SUMMARY

To overcome the disadvantages of conventional technologies, the objective of the present disclosure is to provide an electrolyte solution and a battery including the same. In the present disclosure, a nitrogen-containing heterocyclic compound containing a sulfonate group or a sulfone group is introduced into the electrolyte solution, to inhibit lithium deposition at a negative electrode of a high-voltage battery whose voltage is 4.35 V or above (especially a battery using a nickel-cobalt-manganese ternary material or a battery using a nickel-cobalt-aluminum ternary material) while improving the high-temperature cycling performance, normal-temperature cycling performance, low-temperature discharge performance, and rate performance of the battery.

Further, by introducing a combination of a nitrogen-containing heterocyclic compound containing a sulfonate group or a sulfone group and a fluorinated cyclic carbonate compound into the electrolyte solution, further consumption of a single fluorinated cyclic carbonate compound in the electrolyte solution and reaction between the electrolyte solution and a negative electrode interface can be effectively avoided, thereby inhibiting lithium deposition at the negative electrode of the high-voltage battery whose voltage is 4.35 V or above while further enhancing the high-temperature cycling performance, normal-temperature cycling performance, low-temperature discharge performance, and rate performance of the battery.

The objective of the present disclosure is implemented by using the following technical solutions.

An electrolyte solution is provided. The electrolyte solution includes an electrolyte salt, an organic solvent, and an additive. The additive includes a nitrogen-containing heterocyclic compound containing a sulfonate group or a sulfone group.

According to an implementation of the present disclosure, the electrolyte solution is used in a battery using a nickel-cobalt-manganese ternary material or a battery using a nickel-cobalt-aluminum ternary material.

Beneficial effects of the present disclosure are as follows.

The present disclosure provides an electrolyte solution and a battery including the same. In the electrolyte solution provided in the present disclosure, a nitrogen-containing heterocyclic compound containing a sulfonate group or a sulfone group is a dual-function additive, where there is a lone pair on its N atom; after a small amount of the compound is added to the electrolyte solution, relatively weak Lewis basicity is presented; and the compound can form a complex (for example, a six-ligand complex) with another component (for example, PF5, phosphorus pentafluoride) in the electrolyte solution. Therefore, acidity and reactivity of the electrolyte solution are reduced; and increase of a free acid in the electrolyte solution is inhibited. In addition, a nitrogen-containing heterocyclic compound containing a sulfonate group or a sulfone group can form, on a positive electrode and a negative electrode during a first charge-discharge cycle, outer interface films that include large amounts of LiSO₃, ROSO₂Li, and LiₓN_{y}O_{z} (0<x≤3, 0<y≤1, and 2<z≤3), so that high-temperature performance is high, impedance is low, convenience is brought for migration of lithium ions, and lithium deposition at a negative electrode of a high-voltage battery may be inhibited while the high-temperature cycling performance, normal-temperature cycling performance, low-temperature discharge performance, and rate performance of the battery are improved.

Based on this, when both the nitrogen-containing heterocyclic compound containing a sulfonate group or a sulfone group and a fluorinated cyclic carbonate compound are added into the electrolyte solution, a synergistic effect is produced between the two compounds, and the two compounds jointly act on a positive electrode surface and a negative electrode surface. Therefore, lithium deposition at the negative electrode of the high-voltage battery can be inhibited while the high-temperature cycling performance, normal-temperature cycling performance, low-temperature discharge performance, and rate performance of the battery are further enhanced; and further consumption of a single fluorinated cyclic carbonate compound in the electrolyte solution and reaction between the electrolyte solution and a negative electrode interface can be effectively avoided.

### DETAILED DESCRIPTION OF THE EMBODIMENTS

Specific implementations of the present disclosure are described below in detail. It should be understood that the specific implementations described herein are merely intended to illustrate and explain the present disclosure rather than to limit the present disclosure.

Unless otherwise defined, all scientific and technical terms used herein have the same meanings as those generally understood by those skilled in the art to which the present disclosure relates.

The present disclosure provides an electrolyte solution. The electrolyte solution includes an electrolyte salt, an organic solvent, and an additive. The additive includes a nitrogen-containing heterocyclic compound containing a sulfonate group or a sulfone group.

According to an implementation of the present disclosure, the nitrogen-containing heterocyclic compound includes a sulfonate group or a sulfone group; and sulfur in the sulfonate group or the sulfone group forms a heterocyclic structure with nitrogen.

According to an implementation of the present disclosure, the electrolyte solution further includes a fluorinated cyclic carbonate compound.

According to an implementation of the present disclosure, the fluorinated cyclic carbonate compound includes a carbonate group; and the carbonate group forms a cyclic structure with an alkyl group.

According to an implementation of the present disclosure, the nitrogen-containing heterocyclic compound containing a sulfonate group or a sulfone group is selected from at least one of compounds shown in Formula 1:

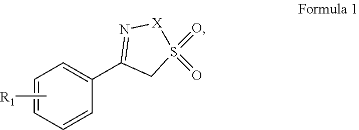

where in Formula 1, X is —O— or —N(R₂)—;
R₁ is H, halogen, or a substituted or an unsubstituted alkyl group, when R₁ is a substituted alkyl group, a substituent is halogen or an alkyl group; and
R₂ is a substituted or an unsubstituted aryl group or a substituted or an unsubstituted alkyl group, when R₂ is a substituted aryl group or alkyl group, a substituent is a halogen or an alkyl group.

According to an implementation of the present disclosure, R₁ is H, halogen, or a substituted or an unsubstituted C₁₋₁₂ alkyl group, when R₁ is a substituted C₁₋₁₂ alkyl group, a substituent is halogen or a C₁₋₁₂ alkyl group; and R₂ is a substituted or an unsubstituted C₆₋₂₀ aryl group or a substituted or an unsubstituted C₁₋₁₂ alkyl group, when R₂ is a substituted C₆₋₂₀ aryl group or C₁₋₁₂ alkyl group, a substituent is a halogen or a C₁₋₁₂ alkyl group.

According to an implementation of the present disclosure, R₁ is H, halogen, or a substituted or an unsubstituted C₁₋₆ alkyl group, when R₁ is a substituted C₁₋₆ alkyl group, a substituent is halogen or a C₁₋₆ alkyl group; and R₂ is a substituted or an unsubstituted C₆₋₁₀ aryl group or a substituted or an unsubstituted C₁₋₆ alkyl group, when R₂ is a substituted C₆₋₁₀ aryl group or C₁₋₆ alkyl group, a substituent is a halogen or a C₁₋₆ alkyl group.

According to an implementation of the present disclosure, R₁ is H, halogen, or a substituted or an unsubstituted C₁₋₃ alkyl group, when R₁ is a substituted C₁₋₃ alkyl group, a substituent is halogen or a C₁₋₃ alkyl group; and R₂ is a substituted or an unsubstituted phenyl group or a substituted or an unsubstituted C₁₋₃ alkyl group, when R₂ is a substituted phenyl group or C₁₋₃ alkyl group, a substituent is a halogen or a C₁₋₃ alkyl group.

According to an implementation of the present disclosure, the nitrogen-containing heterocyclic compound containing a sulfonate group or a sulfone group is selected from at least one of compounds A to H:

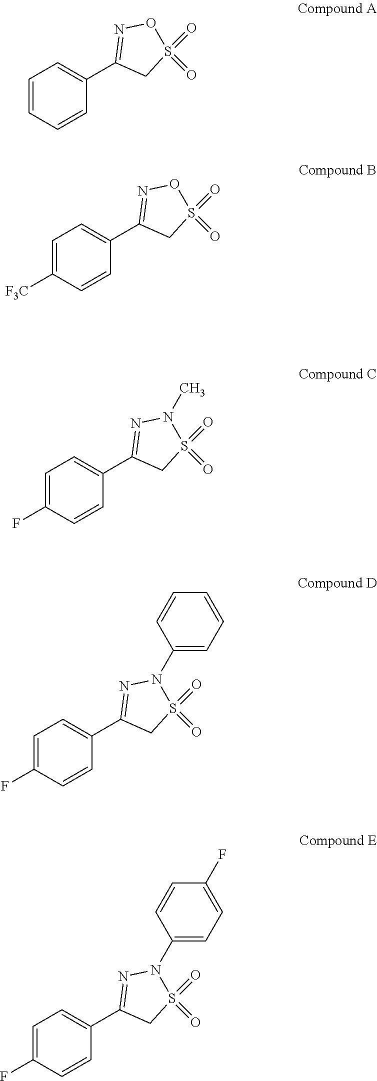 [SMILES: O=S1(=O)CC(c2ccccc2)=NO1 ; O=S1(=O)CC(c2ccc(C(F)(F)F)cc2)=NO1 ; CN1N=C(c2ccc(F)cc2)CS1(=O)=O ; O=S1(=O)CC(c2ccc(F)cc2)=NN1c1ccccc1 ; O=S1(=O)CC(c2ccc(F)cc2)=NN1c1ccc(F)cc1]

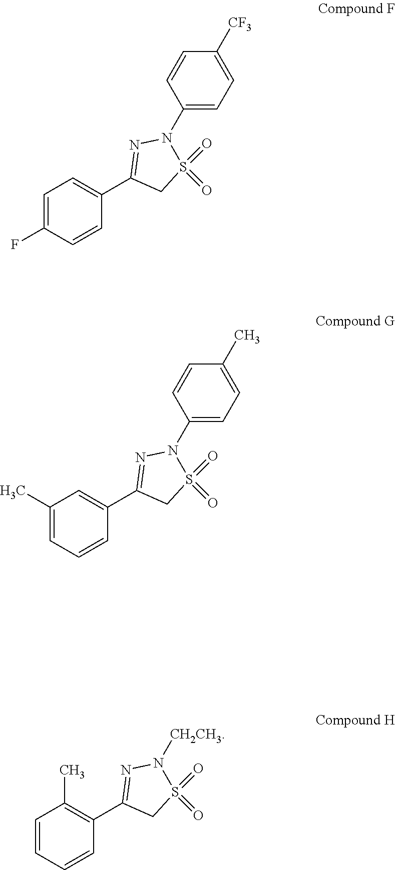

According to an implementation of the present disclosure, the nitrogen-containing heterocyclic compound containing a sulfonate group or a sulfone group may be purchased commercially or may be prepared by using a method known in the art.

According to an implementation of the present disclosure, a mass of the nitrogen-containing heterocyclic compound containing a sulfonate group or a sulfone group accounts for 0.05 wt % to 1 wt % of a total mass of the electrolyte solution, and preferably, accounts for 0.1 wt % to 0.5wt %, for example, accounts for 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, or a point value in a range formed by any two of the foregoing point values. When the mass proportion of the nitrogen-containing heterocyclic compound containing a sulfonate group or a sulfone group is within the foregoing range, the nitrogen-containing heterocyclic compound containing a sulfonate group or a sulfone group can play a better role, which is beneficial for decreasing impedance of a battery and promoting migration of lithium ions, and further improves the high-temperature cycling performance, normal-temperature cycling performance, rate performance, and low-temperature discharge performance of the battery.

According to an implementation of the present disclosure, the fluorinated cyclic carbonate compound is selected from at least one of compounds shown in Formula 2:

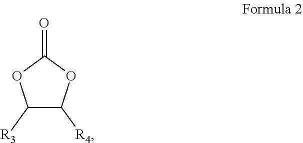

where in Formula 2, R₃ and R₄ are the same as or different from each other, are each independently selected from H, F, or a substituted or an unsubstituted alkyl group, and each contains at least one F atom, when R₃ and R₄ are each a substituted alkyl group, a substituent is F or an alkyl group.

According to an implementation of the present disclosure, in formula 2, R₃ and R₄ are the same as or different from each other, are each independently selected from H, F, or a substituted or an unsubstituted C₁₋₆ alkyl group, and each contains at least one F atom, when R₃ and R₄ are each a substituted C₁₋₆ alkyl group, a substituent is F or a C₁₋₆ alkyl group.

According to an implementation of the present disclosure, in formula 2, R₃ and R₄ are the same as or different from each other, are each independently selected from H, F, or a substituted or an unsubstituted C₁₋₃ alkyl group, and each contains at least one F atom, when R₃ and R₄ are each a substituted C₁₋₃ alkyl group, a substituent is F or a C₁₋₃ alkyl group.

According to an implementation of the present disclosure, the fluorinated cyclic carbonate compound may be purchased commercially or may be prepared by using a method known in the art.

According to an implementation of the present disclosure, a mass of the fluorinated cyclic carbonate compound accounts for 0.5 wt % to 12 wt % of a total mass of the electrolyte solution, and preferably, accounts for 1 wt % to 10 wt %, for example, accounts for 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, or a point value in a range formed by any two of the foregoing point values. When the mass proportion of the fluorinated cyclic carbonate compound is within the foregoing range, a more stable LiF-rich interface film can be formed, which increases the penetration and diffusion capabilities of lithium ions on a negative electrode interface, and further increases the low-temperature performance and rate performance of a lithium-ion battery.

According to an implementation of the present disclosure, the fluorinated cyclic carbonate compound is selected from at least one of the following compounds 1 to 6:

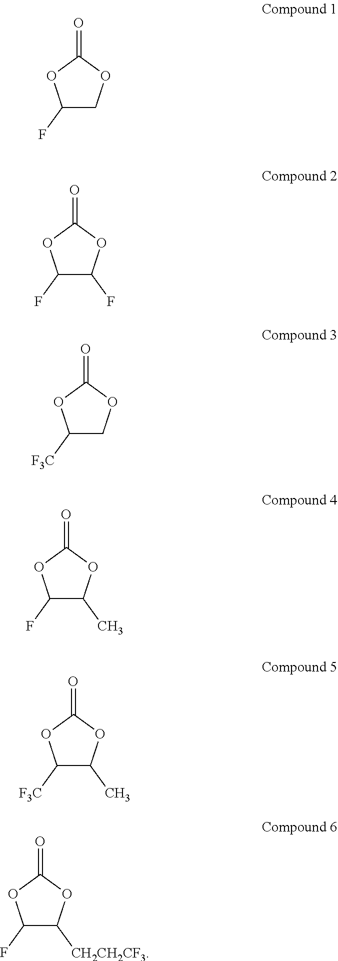

According to an implementation of the present disclosure, the electrolyte salt is selected from at least one of an electrolyte lithium salt, an electrolyte sodium salt, an electrolyte magnesium salt, or the like.

According to an implementation of the present disclosure, the electrolyte lithium salt is selected from at least one of lithium hexafluorophosphate, lithium difluorophosphate, lithium bisoxalate borate, lithium difluoro(oxalato)borate, lithium difluoro oxalate phosphate, lithium tetrafluoroborate, lithium tetrafluoro(oxalato)phosphate, lithium bis(trifluoromethanesulphonyl)imide, or lithium bis(fluorosulfonyl)imide. The ionic conductivity of the electrolyte solution can be improved by adding the foregoing electrolyte lithium salt into the electrolyte solution, so that a migration rate of lithium ions in the electrolyte solution is accelerated, and cycling performance of a battery is improved.

According to an implementation of the present disclosure, a mass of the electrolyte salt accounts for 13 wt % to 20 wt % of a total mass of the electrolyte solution, for example, accounts for 13 wt %, 14 wt %, 15 wt %, 16 wt %, 17 wt %, 18 wt %, 19 wt %, 20 wt %, or a point value in a range formed by any two of the foregoing point values.

According to an implementation of the present disclosure, the organic solvent is selected from at least two of propylene carbonate, ethyl methyl carbonate, ethylene carbonate, dimethyl carbonate, diethyl carbonate, fluoroethylene carbonate, gamma-butyrolactone, sulfolane, methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, or butyl butyrate.

The present disclosure further provides a battery. The battery includes the foregoing electrolyte solution.

According to an implementation of the present disclosure, the battery is a lithium-ion battery.

According to an implementation of the present disclosure, the battery is a nickel-cobalt-manganese ternary battery or a nickel-cobalt-aluminum ternary battery.

According to an implementation of the present disclosure, the battery further includes a positive electrode plate containing a positive electrode active material, a negative electrode plate containing a negative electrode active material, and a separator.

According to an implementation of the present disclosure, the positive electrode plate includes a positive electrode current collector and a positive electrode active material layer coated on one or two side surfaces of the positive electrode current collector; and the positive electrode active material layer includes a positive electrode active material, a conductive agent, and a binder.

According to an implementation of the present disclosure, the negative electrode plate includes a negative electrode current collector and a negative electrode active material layer coated on one or two side surfaces of the negative electrode current collector; and the negative electrode active material layer includes a negative electrode active material, a conductive agent, and a binder.

According to an implementation of the present disclosure, the positive electrode active material layer includes the following components by mass percentage: 80 wt % to 99.8 wt % of the positive electrode active material, 0.1 wt % to 10 wt % of the conductive agent, and 0.1 wt % to 10 wt % of the binder.

Preferably, the positive electrode active material layer includes the following components by mass percentage: 90 wt % to 99.6 wt % of the positive electrode active material, 0.2 wt % to 5 wt % of the conductive agent, and 0.2 wt % to 5 wt % of the binder.

According to an implementation of the present disclosure, the negative electrode active material layer includes the following components by mass percentage: 80 wt % to 99.8 wt % of the negative electrode active material, 0.1 wt % to 10 wt % of the conductive agent, and 0.1 wt % to 10 wt % of the binder.

Preferably, the negative electrode active material layer includes the following components by mass percentage: 90 wt % to 99.6 wt % of the negative electrode active material, 0.2 wt % to 5 wt % of the conductive agent, and 0.2 wt % to 5 wt % of the binder.

According to an implementation of the present disclosure, the conductive agent is selected from at least one of conductive carbon black, acetylene black, Ketjen black, conductive graphite, conductive carbon fiber, carbon nanotube, or metal powder.

According to an implementation of the present disclosure, the binder is selected from at least one of sodium carboxymethyl cellulose, styrene-butadiene latex, polytetrafluoroethylene, or polyethylene oxide.

According to an implementation of the present disclosure, the positive electrode active material is selected from LiNiₓCo_{y}Mn_{z}M¹_{(1-x-y-z)}O₂ or LiNiₓCo_{y}Al_{z}M²_{(1-x-y-z)}O₂, where M¹ is any one of Mg, Cu, Zn, Al, Sn, B, Ga, Cr, Sr, V, or Ti; M² is any one of Mn, Mg, Cu, Zn, Sn, B, Ga, Cr, Sr, V, or Ti; 0.5≤x<1; 0<y≤1; 0<z≤1; and x+y+z≤1.

According to an implementation of the present disclosure, the negative electrode active material is selected from at least one of artificial graphite, natural graphite, hard carbon, soft carbon, mesocarbon microbead, a silicon-based negative electrode material, or a lithium-containing metal composite oxide material.

According to an implementation of the present disclosure, a charge cut-off voltage of the battery is 4.35 V or above.

The present disclosure is further described in detail below with reference to specific examples. It should be understood that the following examples are merely for the purposes of illustrating and explaining the present disclosure, and should not be construed as limiting the protection scope of the present disclosure. All technologies implemented based on the foregoing content of the present disclosure are within the protection scope of the present disclosure.

All experimental methods used in the following examples are conventional methods, unless otherwise specified. Reagents, materials, and the like that are used in the following examples may be all obtained from commercial sources, unless otherwise specified.

### Preparation of a Lithium-Ion Battery

### (1) Preparation of a Positive Electrode Plate

A positive electrode active material (a lithium nickel cobalt manganese oxide ternary material LiNi_{0.6}Mn_{0.2}Co_{0.2}O₂ (NCM622)), a binder (polyvinylidene fluoride (PVDF)), and a conductive agent (acetylene black) were mixed at a weight ratio of 96.5:2:1.5, added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 12 μm. The coated aluminum foil was baked in a five-stage oven with different temperatures and then dried in an oven at 120° C. for 8 hours, followed by roll-pressing and die cutting, to obtain the positive electrode plate.

### (2) Preparation of a Negative Electrode Plate

A negative electrode active material (artificial graphite), a thickener (sodium carboxymethyl cellulose (CMC-Na)), a binder (styrene-butadiene rubber), a conductive agent (acetylene black), and a conductive agent (single-walled carbon nanotube (SWCNT)) were mixed at a weight ratio of 95.9:1:1.8:1:0.3, and added into deionized water. The mixture was stirred under action of a vacuum mixer to obtain a negative electrode slurry. The negative electrode slurry was evenly applied on copper foil having a thickness of 8 μm, followed by baking (temperature: 85° C., time: 5 hours), roll-pressing, and die cutting to obtain the negative electrode plate.

### (3) Preparation of an Electrolyte Solution

In an argon-filled glove box (moisture<10 ppm, oxygen<1 ppm), ethylene carbonate (EC), propylene carbonate (PC), ethyl methyl carbonate (EMC), and diethyl carbonate (DEC) were evenly mixed at a mass ratio of 25:5:60:10, and fully dried lithium hexafluorophosphate accounting for 14.5 wt % of a total mass of the electrolyte solution and an additive (a specific amount and selection of the additive are shown in Table 1) were quickly added into the mixed solution. The mixture was stirred evenly to obtain the electrolyte solution.

### (4) Preparation of a Separator

A polyethylene separator with a coating layer having a thickness of 8 μm was used.

### (5) Preparation of a Lithium-Ion Battery

The prepared positive electrode plate, separator, and negative electrode plate were wound to obtain an unfilled bare cell. The bare cell was placed in outer packaging foil, the prepared electrolyte solution was injected into the dried bare cell, and after processes such as vacuum packaging, standing, formation, secondary encapsulation, and sorting, the lithium-ion battery required was obtained.

Lithium-ion batteries in Comparative Examples 1 and 2 and Examples 1 to 15 were prepared according to the foregoing preparation method. Specific compositions and contents of a lithium salt and an additive are shown in Table 1.

Test results of electrochemical performance of the lithium-ion batteries in Comparative Examples 1 and 2 and Examples 1 to 15 are shown in Table 2.

TABLE 1
Compositions of electrolyte solutions of the lithium-ion batteries
in Comparative Examples 1 and 2 and Examples 1 to 15

| | Nitrogen-containing | Fluorinated cyclic |
|---|---|---|
| | heterocyclic compound | carbonate compound |
| | and its content | and its content |
| Comparative | / | / |
| Example 1 | | |
| Comparative | / | Compound 1, content: 2% |
| Example 2 | | |
| Example 1 | Compound A, content: 0.3% | Compound 1, content: 2% |
| Example 2 | Compound A, content: 0.05% | Compound 1, content: 2% |
| Example 3 | Compound A, content: 1% | Compound 1, content: 2% |
| Example 4 | Compound A, content: 0.3% | Compound 1, content: 0.5% |
| Example 5 | Compound A, content: 0.3% | Compound 1, content: 12% |
| Example 6 | Compound A, content: 0.3% | Compound 2, content: 2% |
| Example 7 | Compound A, content: 0.3% | Compound 3, content: 2% |
| Example 8 | Compound B, content: 0.3% | Compound 1, content: 2% |
| Example 9 | Compound C, content: 0.3% | Compound 1, content: 2% |
| Example 10 | Compound D, content: 0.3% | Compound 1, content: 2% |
| Example 11 | Compound E, content: 0.3% | Compound 1, content: 2% |
| Example 12 | Compound F, content: 0.3% | Compound 1, content: 2% |
| Example 13 | Compound A, content: 0.3% | / |
| Example 14 | Compound A, content: 1.2% | Compound 1, content: 2% |
| Example 15 | Compound A, content: 0.3% | Compound 1, content: 15% |

(1) 25° C. cycling test: The batteries obtained in the foregoing examples and comparative examples were placed in an environment of (25±2)° C., followed by standing for 2 hours to 3 hours. When bodies of the batteries reached a temperature of (25±2)° C., the batteries were charged to 4.35 V at a constant current of 1 C and a constant voltage, and a cut-off current was 0.05 C. The batteries were left aside for 5 minutes after being fully charged, and then discharged at a constant current of 1 C to a cut-off voltage of 3.0 V. The highest discharge capacity in the first three cycles was recorded as an initial capacity Q. When a number of cycles reached a required value, the last discharge capacity Q1 of the battery was recorded. A capacity retention rate was calculated according to a calculation formula: Capacity retention rate (%)=Q1/Q×100%, and was recorded in Table 2.

(2) 45° C. cycling test: The batteries obtained in the foregoing examples and comparative examples were placed in an environment of (45±2)° C., followed by standing for 2 hours to 3 hours. When bodies of the batteries reached a temperature of (45±2)° C., the batteries were charged to 4.35 V at a constant current of 1 C and a constant voltage, and a cut-off current was 0.05 C. The batteries were left aside for 5 minutes after being fully charged, and then discharged at a constant current of 1 C to a cut-off voltage of 3.0 V. The highest discharge capacity in the first three cycles was recorded as an initial capacity Q. When a number of cycles reached a required value, the last discharge capacity Q1 of the battery was recorded. A capacity retention rate was calculated according to a calculation formula: Capacity retention rate (%)=Q1/Q×100%, and was recorded in Table 2.

(3) −10° C. low temperature discharge test: The lithium-ion batteries were discharged at 25° C. at a constant current of 0.5 C to a cut-off voltage of 3 V. After being left aside for 10 minutes, the batteries were charged to 4.35 V at a constant current of 1 C and a constant voltage, and a cut-off current was 0.05 C. Battery cells were moved to a −10° C. low-temperature cabinet, and left aside for 120 minutes. Then, the battery cells were discharged at a constant current of 4 C to a cut-off voltage of 3.0 V. Voltages at inflection points were recorded. The recorded results are shown in Table 2.

(4) −10° C. cycling dissection test: The batteries obtained in the foregoing examples and comparative examples were placed in an environment of (−10±2)° C., followed by standing for 2 hours to 3 hours. When bodies of the batteries reached a temperature of (−10±2)° C., the batteries were charged to 4.35 V at a constant current of 1 C and a constant voltage, and a cut-off current was 0.05 C. The batteries were left aside for 5 minutes after being fully charged, and then discharged at a constant current of 1 C to a cut-off voltage of 3.0 V. The foregoing steps were repeated for 10 cycles. Dissection was carried out to record lithium deposition statuses, where there are three levels of lithium deposition: slight lithium deposition, lithium deposition, and severe lithium deposition. The recorded results are shown in Table 2.

(5) Test for an acidity change after high-temperature storage at 60° C. for 30 days. Acidities of electrolyte solutions prepared in the foregoing examples and comparative examples were tested before storage. Then, acidities of the electrolyte solutions were tested after the electrolyte solutions were stored in a (60±2)° C. thermostat for 30 days. The recorded results are shown in Table 2.

TABLE 2
Performance test results of the lithium-ion batteries and the electrolyte
solutions in Comparative Examples 1 and 2 and Examples 1 to 15

| | | | | | Voltage | |
|---|---|---|---|---|---|---|
| | | | | | inflection | |
| | Acidity change after high- | | 500 | 500 | point during | Dissection |
| | temperature storage at | | cycles at | cycles at | discharge | after 10 |
| | 60° C. for 30 days (ppm) | | 1 C/1 C | 1 C/1 C | at 4 C | cycles of |
| | Before | After | and | and | and −10° C. | 1 C/1 C |
| Group | storage | storage | 25° C. | 45° C. | (V) | at −10° C. |
| Comparative | <10 ppm | 528 ppm | 32.5% | 24.8% | 2.98 | Lithium |
| Example 1 | | | | | | deposition |
| Comparative | <10 ppm | 109 ppm | 45.8% | 36.9% | 2.88 | Lithium |
| Example 2 | | | | | | deposition |
| Example 1 | <10 ppm | 55 ppm | 88.7% | 82.6% | 3.39 | No lithium |
| | | | | | | deposition |
| Example 2 | <10 ppm | 87 ppm | 79.7% | 72.9% | 3.26 | No lithium |
| | | | | | | deposition |
| Example 3 | <10 ppm | 50 ppm | 81.6% | 74.6% | 3.28 | No lithium |
| | | | | | | deposition |
| Example 4 | <10 ppm | 63 ppm | 82.1% | 75.7% | 3.30 | No lithium |
| | | | | | | deposition |
| Example 5 | <10 ppm | 58 ppm | 76.3% | 69.9% | 3.19 | Slight |
| | | | | | | lithium |
| | | | | | | deposition |
| Example 6 | <10 ppm | 60 ppm | 85.7% | 80.6% | 3.31 | No lithium |
| | | | | | | deposition |
| Example 7 | <10 ppm | 56 ppm | 86.2% | 81.1% | 3.32 | No lithium |
| | | | | | | deposition |
| Example 8 | <10 ppm | 63 ppm | 84.7% | 79.6% | 3.34 | No lithium |
| | | | | | | deposition |
| Example 9 | <10 ppm | 61 ppm | 87.0% | 81.6% | 3.32 | No lithium |
| | | | | | | deposition |
| Example 10 | <10 ppm | 59 ppm | 85.9% | 79.9% | 3.29 | No lithium |
| | | | | | | deposition |
| Example 11 | <10 ppm | 57 ppm | 86.2% | 80.9% | 3.35 | No lithium |
| | | | | | | deposition |
| Example 12 | <10 ppm | 62 ppm | 85.5% | 81.0% | 3.31 | No lithium |
| | | | | | | deposition |
| Example 13 | <10 ppm | 60 ppm | 75.5% | 68.7% | 3.26 | No lithium |
| | | | | | | deposition |
| Example 14 | <10 ppm | 55 ppm | 73.6% | 67.8% | 3.16 | Lithium |
| | | | | | | deposition |
| Example 15 | <10 ppm | 58 ppm | 73.3% | 67.5% | 3.15 | Lithium |
| | | | | | | deposition |

It may be learned from the foregoing Example 13 and Comparative Example 1 that adding a nitrogen-containing heterocyclic compound containing a sulfonate group or a sulfone group into an electrolyte solution may improve the high-temperature cycling performance, normal-temperature cycling performance, rate performance, and low-temperature discharge performance of a battery including the electrolyte solution, and more importantly, can effectively avoid low-temperature lithium deposition. This is because there is a lone pair on an N atom of the nitrogen-containing heterocyclic compound containing a sulfonate group or a sulfone group, relatively weak Lewis basicity may be presented only by adding a small amount of the compound into the electrolyte solution, and the compound can form a complex (for example, a six-ligand complex) with another component (for example, PFs) in the electrolyte solution. Therefore, acidity and reactivity of the electrolyte solution are reduced; and increase of a free acid in the electrolyte solution is inhibited. A nitrogen-containing heterocyclic compound containing a sulfonate group or a sulfone group can form, on a positive electrode and a negative electrode during a first charge-discharge cycle, outer interface films that include large amounts of LiSO₃, ROSO₂Li, and LiₓN_{y}O_{z}, so that high-temperature performance is high, impedance is low, and convenience is brought for migration of lithium ions. A fluorinated cyclic carbonate compound forms, on the negative electrode, an interface film containing components such as LiF, and is evenly dispersed on a surface of the negative electrode.

Further, it may be learned from the foregoing Examples 1 to 15 and Comparative Examples 1 and 2 that the interface film formed by the nitrogen-containing heterocyclic compound containing a sulfonate group or a sulfone group can inhibit lithium deposition, has high stability, and can improve cycling performance to some extent. After the fluorinated cyclic carbonate compound is further added on this basis, the fluorinated cyclic carbonate compound may form a LiF-rich interface film on the negative electrode in a first charge-discharge phase. The interface film can significantly increase the penetration and diffusion capabilities of lithium ions on a negative electrode interface. Therefore, the low-temperature performance and rate performance of a lithium-ion battery can be increased.

However, during a late cycle or after a low-temperature long cycle of an electrolyte solution into which only a fluorinated cyclic carbonate compound is added, a lithium deposition problem cannot be resolved. In addition, because the nitrogen-containing heterocyclic compound containing a sulfonate group or a sulfone group is not added, a positive electrode interface is in direct contact with the electrolyte solution to catalyze decomposition of the electrolyte solution, resulting in obvious deterioration of normal-temperature cycling performance and high-temperature cycling performance.

The foregoing describes the implementations of the present disclosure. However, the present disclosure is not limited to the foregoing implementations. Any modifications, equivalent replacements, improvements, or the like made without departing from the spirit and principle of the present disclosure shall fall within the protection scope of the present disclosure.

What is claimed is:

1. An electrolyte solution, comprising an electrolyte salt, an organic solvent, and an additive;
wherein the additive comprises a nitrogen-containing heterocyclic compound containing a sulfonate group or a sulfone group.

2. The electrolyte solution according to claim 1, wherein the nitrogen-containing heterocyclic compound comprises a sulfonate group or a sulfone group; and sulfur in the sulfonate group or the sulfone group forms a heterocyclic structure with nitrogen.

3. The electrolyte solution according to claim 1, wherein the nitrogen-containing heterocyclic compound containing a sulfonate group or a sulfone group is selected from at least one of compounds shown in Formula 1: 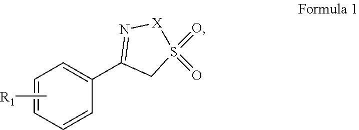
wherein in Formula 1, X is —O— or —N (R₂)—;
R₁ is H, halogen, or a substituted or an unsubstituted alkyl group, when R₁ is a substituted alkyl group, a substituent is halogen or an alkyl group; and
R₂ is a substituted or an unsubstituted aryl group or a substituted or an unsubstituted alkyl group, when R₂ is a substituted aryl group or alkyl group, a substituent is a halogen or an alkyl group.

4. The electrolyte solution according to claim 3, wherein in Formula 1, R₁ is H, halogen, or a substituted or an unsubstituted C₁₋₁₂ alkyl group, when R₁ is a substituted C₁₋₁₂ alkyl group, a substituent is halogen or a C₁₋₁₂ alkyl group; and
R₂ is a substituted or an unsubstituted C₆₋₂₀ aryl group or a substituted or an unsubstituted C₁₋₁₂ alkyl group, when R₂ is a substituted C₆₋₂₀ aryl group or C₁₋₁₂ alkyl group, a substituent is a halogen or a C₁₋₁₂ alkyl group.

5. The electrolyte solution according to claim 4, wherein in Formula 1, R₁ is H, halogen, or a substituted or an unsubstituted C₁₋₃ alkyl group, when R₁ is a substituted C₁₋₃ alkyl group, a substituent is a halogen or a C₁₋₃ alkyl group; and
R₂ is a substituted or an unsubstituted phenyl group or a substituted or an unsubstituted C₁₋₃ alkyl group, when R₂ is a substituted phenyl group or C₁₋₃ alkyl group, a substituent is halogen or a C₁₋₃ alkyl group.

6. The electrolyte solution according to claim 1, wherein the nitrogen-containing heterocyclic compound containing a sulfonate group or a sulfone group is selected from at least one of compounds A to H:

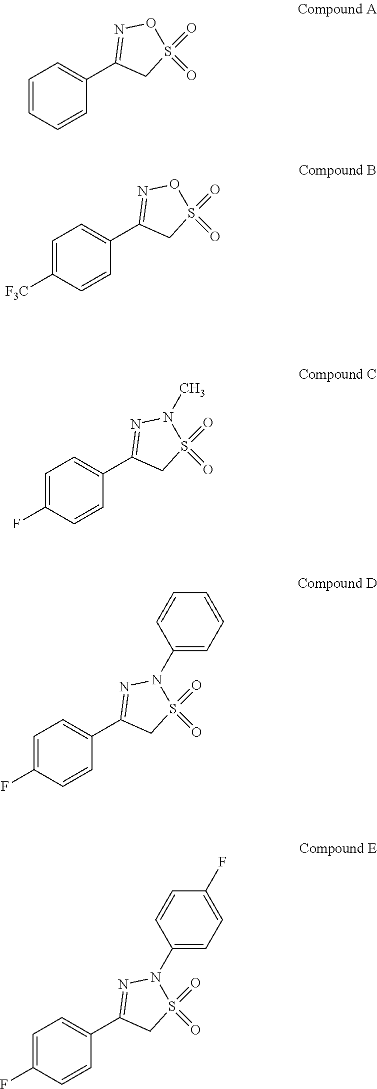 [SMILES: O=S1(=O)CC(c2ccccc2)=NO1 ; O=S1(=O)CC(c2ccc(C(F)(F)F)cc2)=NO1 ; CN1N=C(c2ccc(F)cc2)CS1(=O)=O ; O=S1(=O)CC(c2ccc(F)cc2)=NN1c1ccccc1 ; O=S1(=O)CC(c2ccc(F)cc2)=NN1c1ccc(F)cc1]

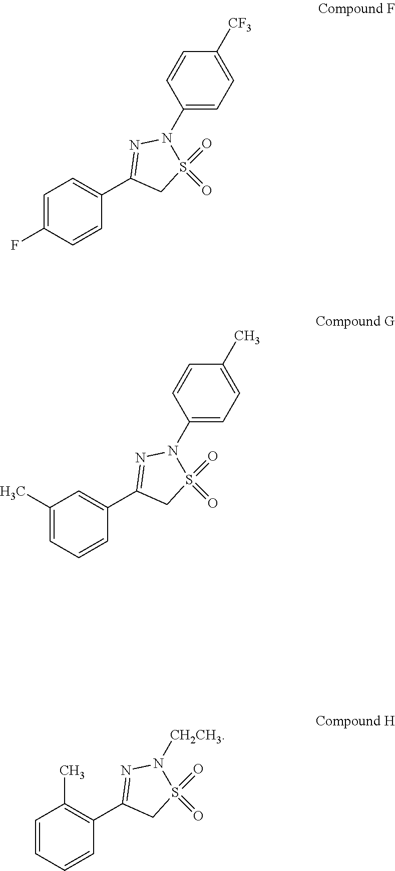

7. The electrolyte solution according to claim 1, wherein a mass of the nitrogen-containing heterocyclic compound containing a sulfonate group or a sulfone group accounts for 0.05 wt % to 1 wt % of a total mass of the electrolyte solution.

8. The electrolyte solution according to claim 7, wherein the mass of the nitrogen-containing heterocyclic compound containing a sulfonate group or a sulfone group accounts for 0.1 wt % to 0.5 wt % of the total mass of the electrolyte solution.

9. The electrolyte solution according to claim 1, further comprising a fluorinated cyclic carbonate compound.

10. The electrolyte solution according to claim 9, wherein the fluorinated cyclic carbonate compound comprises a carbonate group; and the carbonate group forms a cyclic structure with an alkyl group.

11. The electrolyte solution according to claim 9, wherein the fluorinated cyclic carbonate compound is selected from at least one of compounds shown in Formula 2: 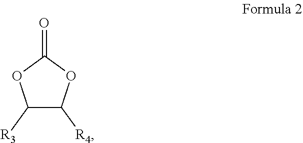
wherein in Formula 2, R₃ and R₄ are the same as or different from each other, are each independently selected from H, F, or a substituted or an unsubstituted alkyl group, and each contains at least one F atom, when R₃ and R₄ are each a substituted alkyl group, a substituent is F or an alkyl group.

12. The electrolyte solution according to claim 11, wherein in formula 2, R₃ and R₄ are the same as or different from each other, are each independently selected from H, F, or a substituted or an unsubstituted C₁₋₆ alkyl group, and each contains at least one F atom, when R₃ and R₄ are each a substituted C₁₋₆ alkyl group, a substituent is F or a C₁₋₆ alkyl group.

13. The electrolyte solution according to claim 11, wherein in formula 2, R₃ and R₄ are the same as or different from each other, are each independently selected from H, F, or a substituted or an unsubstituted C₁₋₃ alkyl group, and each contains at least one F atom, when R₃ and R₄ are each a substituted C₁₋₃ alkyl group, a substituent is F or a C₁₋₃ alkyl group.

14. The electrolyte solution according to claim 11, wherein the fluorinated cyclic carbonate compound is selected from at least one of the following compounds 1 to 6:

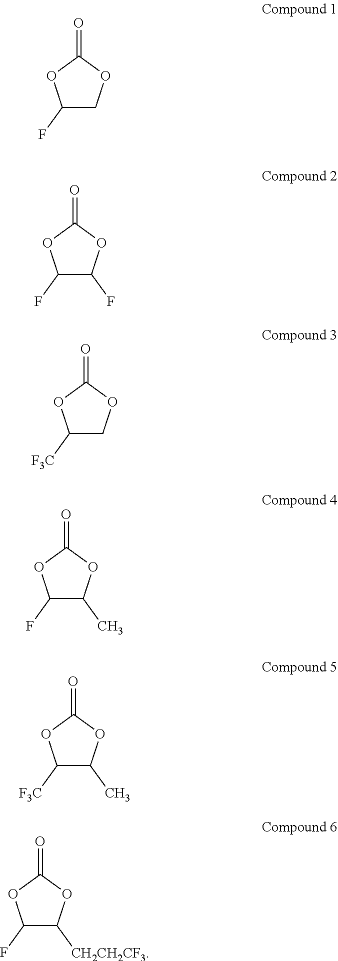

15. The electrolyte solution according to claim 9, wherein a mass of the fluorinated cyclic carbonate compound accounts for 0.5 wt % to 12 wt % of a total mass of the electrolyte solution.

16. The electrolyte solution according to claim 15, wherein the mass of the fluorinated cyclic carbonate compound accounts for 1 wt % to 10 wt % of the total mass of the electrolyte solution.

17. The electrolyte solution according to claim 1, wherein the electrolyte salt is selected from at least one of an electrolyte lithium salt, an electrolyte sodium salt, or an electrolyte magnesium salt.

18. The electrolyte solution according to claim 17, wherein a mass of the electrolyte salt accounts for 13 wt % to 20 wt % of a total mass of the electrolyte solution.

19. A battery, comprising the electrolyte solution according to claim 1.

20. The battery according to claim 19, wherein the battery further comprises a positive electrode plate containing a positive electrode active material; and the positive electrode active material is selected from LiNiₓCo_{y}Mn_{z}M¹_{(1-x-y-z)}O₂ or LiNiₓCo_{y}Al_{z}M²_{(1-x-y-z)}O₂, wherein M¹ is any one of Mg, Cu, Zn, Al, Sn, B, Ga, Cr, Sr, V, or Ti; M² is any one of Mn, Mg, Cu, Zn, Sn, B, Ga, Cr, Sr, V, or Ti; 0.5≤x<1; 0<y≤1; 0<z≤1; and x+y+z≤1.
